(19) United States
(12) Patent Application Publication
(10) Pub. No.: US 2011/0108530 A1
(43) Pub. Date: May 12, 2011

(54) SYSTEM AND METHOD FOR WELDING

(76) Inventors: Andrew V. Martin, Granger, IN (US); John K. Martin, Elkhart, IN (US)

(21) Appl. No.: 12/941,565

(22) Filed: Nov. 8, 2010

Related U.S. Application Data
(60) Provisional application No. 61/258,807, filed on Nov. 6, 2009.

(51) Int. Cl. B23K 26/24; B23K 26/00

(52) U.S. Cl. 219/121.64; 219/121.63

(57) ABSTRACT

A method and system for creating metal beams utilizes laser welding to fusion weld top and bottom flanges to a metal web in a continuous fashion wherein the flanges and web are fed from coils. The system and method allow custom I-beams or T-beams to be more easily manufactured, as well as allowing the beams to be more economically manufactured with a smaller factory footprint and with a reduced amount of equipment. The system may include a coil feed subsystem, a conveyor, a first laser welder, and a second laser welder. The first and second laser welders weld the metal flange to the metal web along first and second sides, respectively, of the junction of the flange and web as these materials move. The first and second laser welders may be positioned longitudinally along the conveyor such that they simultaneously weld a common longitudinal position along the junction.

### BACKGROUND OF THE INVENTION

The present invention relates to the manufacture of metal beams, and more particularly to a method of manufacturing beams using a laser welding process.

In the past, the manufacture of metal I-beams and metal T-beams has typically been accomplished by one of several different methods, including hot rolling, cold rolling, extrusion, and/or welding. The past welding of I and T beams has been accomplished by using arc welding, such as gas metal arc welding (GMAW) or a hybrid laser-GMAW system. The past welding of I and T beams has also been accomplished using high frequency electric resistance fusion welding.

### SUMMARY OF THE INVENTION

The present invention provides a new method and system for creating metal beams, such as I-beams, T-beams, and the like that overcomes several disadvantages of prior art methods of making such beams. The system and method utilize laser welding to fusion weld top and bottom flanges to a metal web in a continuous fashion wherein the flanges and web are fed from coils. The system and method utilize no filler material. The system and method allow custom I-beams to be more easily manufactured, as well as allowing I-beams to be more economically manufactured with a smaller factory footprint and with a reduced amount of equipment.

According to a first embodiment, a system for making metal beams is provided. The system includes a coil feed subsystem, a conveyor, a first laser welder, and a second laser welder. The coil subsystem feeds from a pair of coils a metal flange and a metal web to a welding area. The conveyor is positioned in the welding area and continuously moves the metal flange and metal web in a downstream direction away from the coil feed subsystem. The metal flange and metal web are in contact with each other along a junction as they move on the conveyor. The first and second laser welders are both positioned in the welding area. The first laser welder welds the metal flange to the metal web along a first side of the junction as the metal flange and metal web move. The second laser welder welds the metal flange to the metal web along a second side of the junction as the metal flange and metal web move. The first and second laser welders are positioned longitudinally along the conveyor such that they simultaneously weld a common longitudinal position along the junction.

According to another embodiment, a method of manufacturing a metal I-beam is provided. The method includes feeding a bottom metal flange from a first coil to a welding area, feeding a top metal flange from a second coil to the welding area, and feeding a metal web from a third coil to the welding area. The method further includes laser welding the bottom metal flange to the metal web and the top metal flange to the metal web to thereby create an I-beam. The laser welding occurs while the top and bottom metal flanges and the web move on a conveyor. The welded I-beam is further cut into sections downstream of the welding area while the I-beam is in motion.

According to still another embodiment, a system for making metal I-beams is provided. The system includes a coil feed subsystem, a conveyor, and first, second, third, and fourth laser welders. The coil subsystem feeds a top metal flange, a bottom metal flange, and a metal web to a welding area. The top metal flange, bottom metal flange, and metal web are fed from first, second, and third coils, respectively. The conveyor is positioned in the welding area and continuously moves the top metal flange, the bottom metal flange, and the metal web in a downstream direction away from the coil feed subsystem. The top metal flange and metal web are in contact with each other along a first junction as they move on the conveyor. The bottom metal flange and the metal web are in contact with each other along a second junction as they move on the conveyor. The first, second, third, and fourth laser welders are all positioned in the welding area. The first laser welder welds the top metal flange to the metal web along a first side of the first junction as the top metal flange and metal web move. The second laser welder welds the top metal flange to the metal web along a second side of the first junction as the top metal flange and metal web move. The third laser welder welds the bottom metal flange to the metal web along a first side of the second junction as the bottom metal flange and metal web move. The fourth laser welder welds the bottom metal flange to the metal web along a second side of the second junction as the bottom metal flange and metal web move.

According to still other aspects of the invention, pairs of the laser welders may be positioned at common longitudinal locations along the conveyor so that the longitudinal axes of the laser beam pairs intersect each other. The first and second laser welders may be aimed, focused, and powered such that they create weld pools at the junction of the web and flange that intersect with each other. The second and third laser welders may also be aimed, focused, and powered such that they create weld pools at the junction of the web and the other flange that intersect with each other. In some embodiments, the web and flanges may all be made of the same material, such as steel, aluminum, or other metals. In other embodiments, one or more of the web and flanges may be made of a different metal than the other two components of the I-beam. The welding may be accomplished without the use of any filler materials. In at least some embodiments, the laser welders may emit a laser beam that is oriented approximately fifteen degrees from the plane defined by either of the flanges. Other orientations can, of course, be used.

### BRIEF DESCRIPTION OF THE DRAWINGS

FIG. 1 is a plan view diagram of a welding system according to one embodiment;

FIG. 2 is a plan view diagram of a coil feed subsystem of the system of FIG. 1;

FIG. 3 is a plan view diagram of a welding area of the system of FIG. 1;

FIG. 4 is a plan view diagram of an exit subsystem of the system of FIG. 1;

FIG. 5 is a cross sectional view of an illustrative I-beam showing the orientation and position of four laser beams;

FIG. 6 is a plan view diagram of a plurality of laser welders welding a metal beam as the beam moves on a conveyor; and

FIG. 7 is a cross section view of an illustrative I-beam showing the size and position of a plurality of weld pools.

### DETAILED DESCRIPTION OF THE EMBODIMENTS

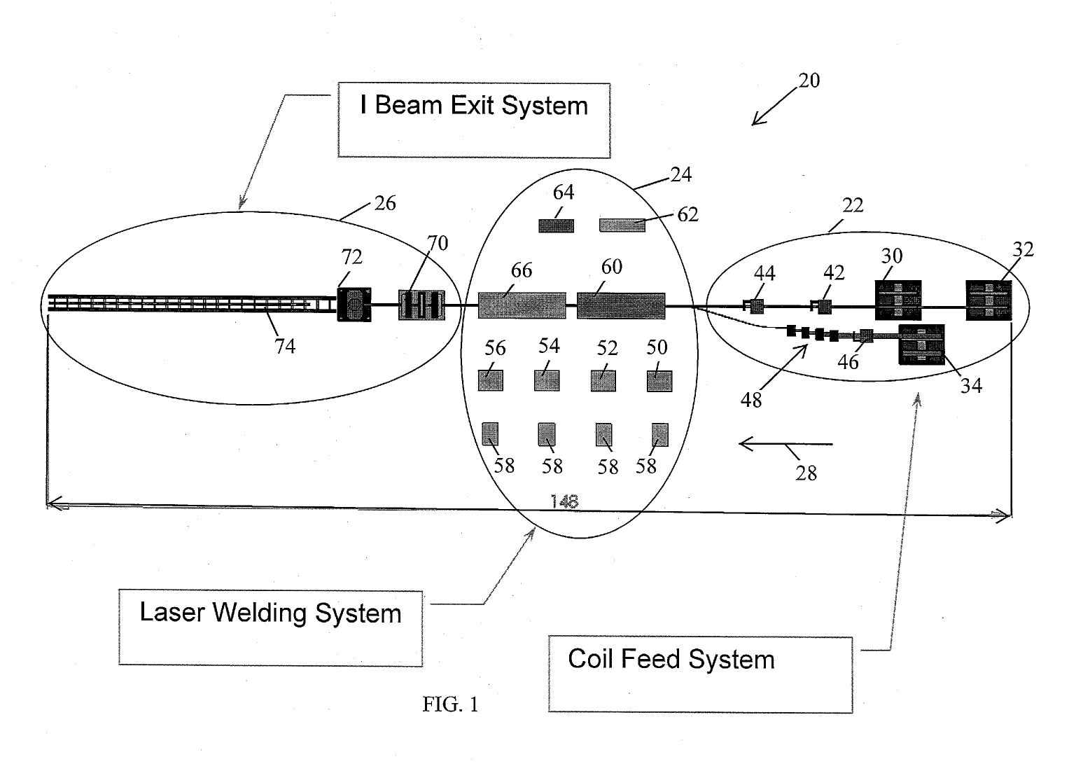

A beam manufacturing system 20 according to one embodiment is depicted schematically in FIG. 1. Beam manufacturing system 20 includes a coil feed subsystem 22, a laser welding area 24, and an exit subsystem 26. Beam manufacturing system 20 is designed to manufacture metal beams, such as, but not limited to, I-beams, T-beams, and other metal beams which may be constructed of metal components that are welded together to create an intermediate or final beam product. Beam manufacturing system 20 is designed to create beams on a continuous basis. That is, during operation, material continuously moves in a downstream direction 28 from coil subsystem 22 to exit subsystem 26. The component materials are fed from coil feed subsystem 22 to welding area 24, where the materials are appropriately welded, and then onto exit system where the materials are cut into sections while still moving. The movement of the component materials occurs even in the welding area 24, allowing the overall system 20 to achieve line speeds of 12 meters per minute, or greater. System 20 may therefore be used to manufacture metal beams at speeds of 12 meters per minute, or more, including up to speeds at least as great as 16 meters per minute.

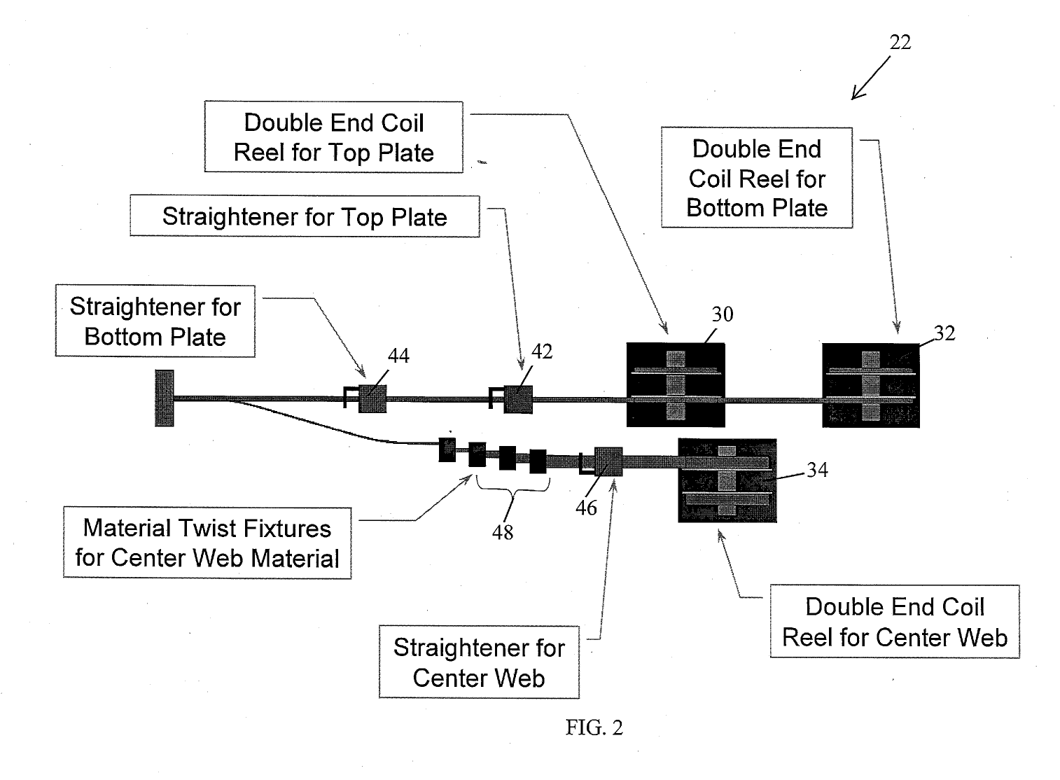

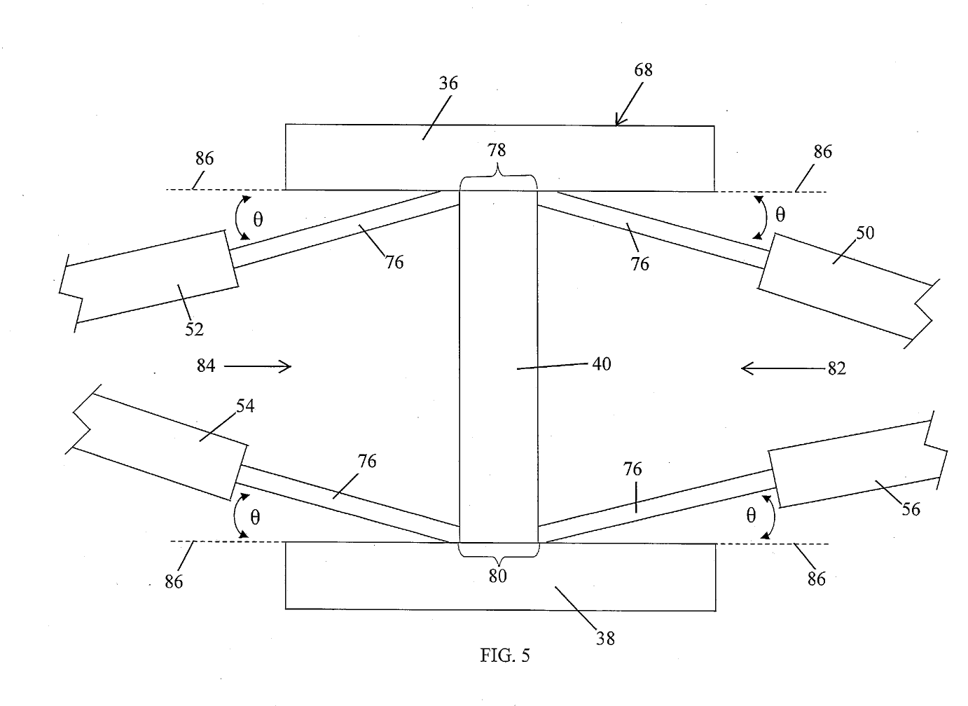

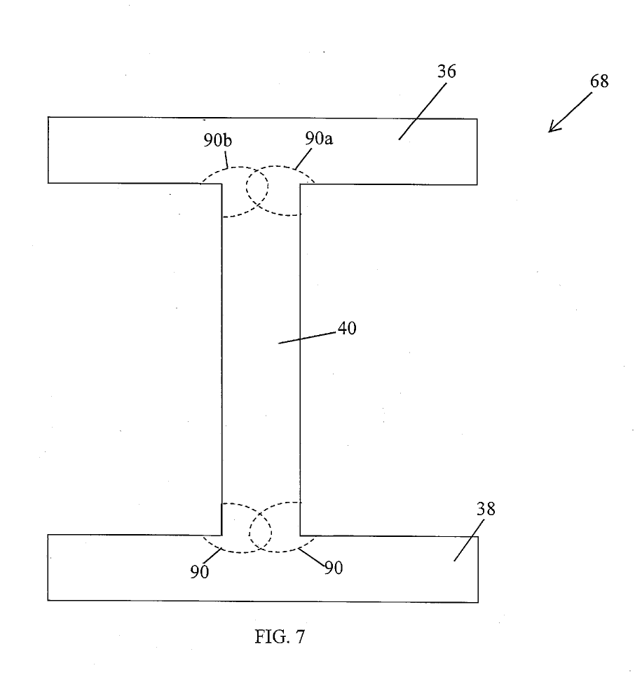

FIG. 2 illustrates one potential configuration of coil feed subsystem 22. In the embodiment shown therein, coil feed subsystem 22 includes a first coil reel 30, a second coil reel 32, and a third coil reel 34. First, second, and third coil reels 30-34 may each be double end coil reels, or some other type of coil reels. Each coil reel 30-34 is adapted to support a coil of metal that forms a component of the beam being manufactured. In the embodiment shown in FIG. 2, there are three coil reels 30-34 because subsystem 22 of FIG. 2 is adapted for constructing an I-beam having a top plate or flange 36, a bottom plate or flange 38, and a web 40 (FIGS. 5 and 7). In other embodiments, such as when system 20 is used to manufacture T-beams, or other products utilizing only two components, coil feed subsystem 22 may include only two coil reels. Regardless of the number of coil reels, they may be conventional coil reels sold by any of multiple different vendors, and a variety of different types of coil reels may be used with coil feed subsystem 22. As such, the detailed construction of the coil reels need not be described further.

While not illustrated in FIG. 2, coil feed subsystem 22 could be modified to include a plurality of accumulators. Such accumulators may be conventional, off-the-shelf accumulators that allow the metal coils to be continuously fed to laser welding area 24, even when the metal from one or more coils is fully consumed and a new coil must be introduced. That is, such accumulators would allow system 20 to continuously operate without stopping, even during time periods where new coils were added to the system. Such accumulators allow a person or machine to weld the end of one metal coil to the beginning of a new metal coil, and do so in a manner that does not interfere with or slow down the continuous supply of the metal to welding area 24. If used, an accumulator would be provided for each of the metal components being fed to welding area 24. Thus, if a T-beam were being welded, subsystem 22 might include only two accumulators. If an I-beam were being welded, subsystem 22 might include three accumulators.

A top flange straightener 42 and a bottom flange straightener 44 are positioned downstream of coil reels 30 and 32. Straighteners 42 and 44 may be any conventional straightener that is adapted to straighten the metal coils supported on first reel 30 and second reel 32, respectively. Such straightening changes the circular shape of the metal while supported on reels 30 and 32 into a straight, flat shape, suitable for manufacturing a metal beam. While FIG. 2 illustrates straightener 42 as being positioned upstream of straightener 44, the order of the straighteners may be changed.

A web straightener 46 is also present in coil feed subsystem 22. Web straightener 46 straightens the coiled metal of third reel 34 as the metal unwinds therefrom. Web straightener 46 then feeds the straightened metal through a plurality of material twist fixtures 48 before the metal is fed to laser welding area 24. Web straightener 46 and material twist fixtures 48 may both be conventional structures. In the illustrated embodiment, third reel 34 supports the metal web material that forms web 40 of the finished beam 68. First reel 30 supports the coiled metal that is used to make the top flange 36 of the finished beam 68, and second reel 32 supports the coiled metal that is used to make bottom flange 38 of the finished beam 68. The arrangement of which reel supports which material may, of course, be changed.

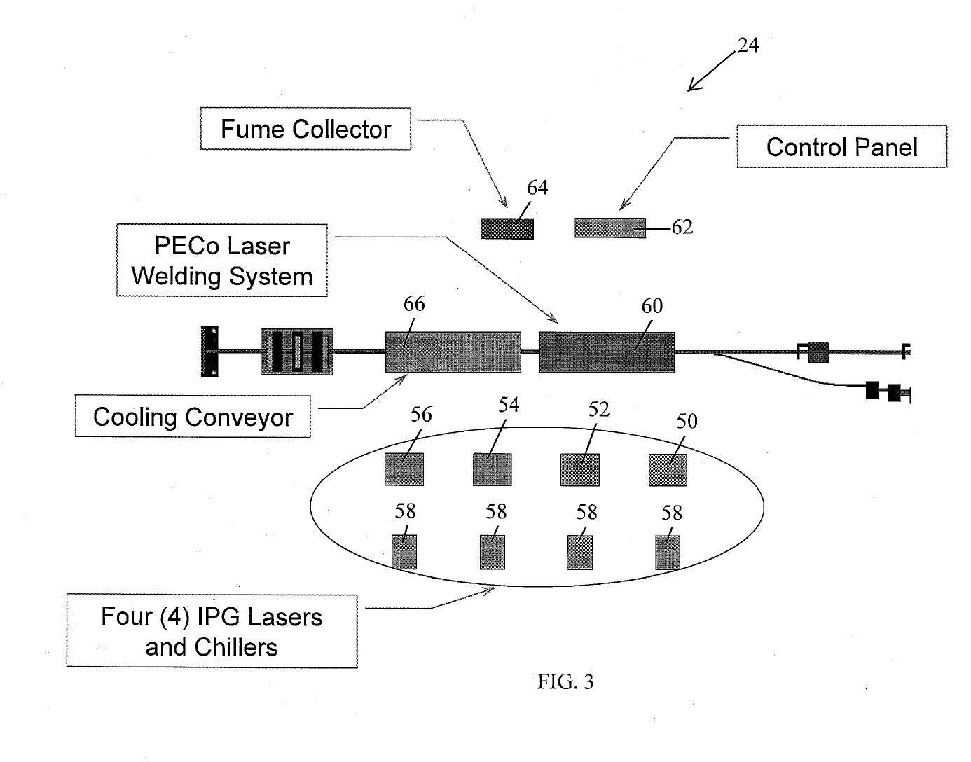

After the metal coils are unwound and straightened in coil feed subsystem 22, they are fed to laser welding area 24. An example of one suitable embodiment of laser welding area 24 is illustrated in more detail in FIG. 3. Laser welding area 24 includes first, second, third, and fourth laser welders 50, 52, 54, and 56, respectively. Laser welders 50-56 may be commercially available, conventional laser welding machines. As but one example, laser welders 50-56 may be any type of yttrium aluminum garnet (YAG) laser, such as ytterbium doped YAG lasers (Yb:YAG), or other YAG lasers doped with other compounds. Still other types of laser welders besides YAG lasers may also be used. One example of a laser welder that may be used in laser welding area 24 is a YLR 4000 model laser welder marketed by IPG Photonics of Oxford, Mass. Other types may, of course, be used.

Laser welders 50-56 may each include a conventional chiller 58 associated therewith. Chillers 58 may be air or liquid cooled and are adapted to prevent laser welders 50-56 from overheating. Laser welders 50-56 are adapted to weld top flange 36 to web 40, as well as bottom flange 38 to web 40, to thereby create an I-beam. If another type of metal beam is to be created by system 20, such as a T-beam, then fewer laser welders may be used. For example, the manufacture of a T-beam could be accomplished using only two laser welders.

Regardless of the specific number, laser welders 50-56 are adapted to weld the components of the beam while the components are traveling on a conveyor 60 in laser welding area 24. Conveyor 60 may be a belted conveyor, or any other suitable type of conveyor that is capable of supporting and moving the straightened metal from reels 30, 32, and 34. Suitable fixturing ensures that the straightened metal components from the reels are maintained in the correct orientation and position relative to each other as they travel on conveyor 60 so that the components may be welded together by laser welders 50-56 as the components are moving on conveyor 60. Thus, laser welders 50-56 may remain stationary and do not require any moving robotic arms to move along the joints being welded. Conventional controls may be utilized to ensure that the lasers emitted from the laser welders 50-56 impinge the correct weld locations on the metal components of the beam as the components move.

While laser welders 50-56 are shown in FIGS. 1 and 3 as all being positioned on one side of conveyor 60, this does not necessarily represent an accurate location of the welders 50-56. Depending upon the particular implementation, some laser welders 50-56 may be positioned on one side of the conveyor 60 and others may be positioned on an opposite side thereof. Further, while the attached drawings show some laser welders 50-56 positioned alongside a cooling conveyor 66, all of the laser welders 50-56 would, in an actual implementation, be positioned at locations that allowed them to carry out their welding operations alongside conveyor 60. The relative time at which each welder 50-56 welds a particular joint relative to the welding of other joints and/or seams will be discussed in greater detail below.

A control panel 62 may be included and in communication with laser welders 50-56 in order to control the welding operation undertaken by welders 50-56. One or more fume collectors 64 may also be present in laser welding area 24 in order to properly vent and/or process fumes created during the welding process. A cooling conveyor 66 may also be positioned downstream of conveyor 60. Cooling conveyor 66 receives the metal beam 68 after its components have been welded together on welding conveyor 60. Because the laser welding performed by laser welders 50-56 is highly focused, the heat generated thereby is not excessive, nor is it spread out over a large area on the beam. Large amounts of space within the plant or factory for cooling are therefore not necessary. Cooling conveyor 66 therefore provides sufficient space to allow sufficient cooling of beam 68 after it has been welded. Cooling conveyor 66 operates continuously and, in addition to allowing beam 68 to cool while traveling thereon, delivers beam 68 to exit subsystem 26.

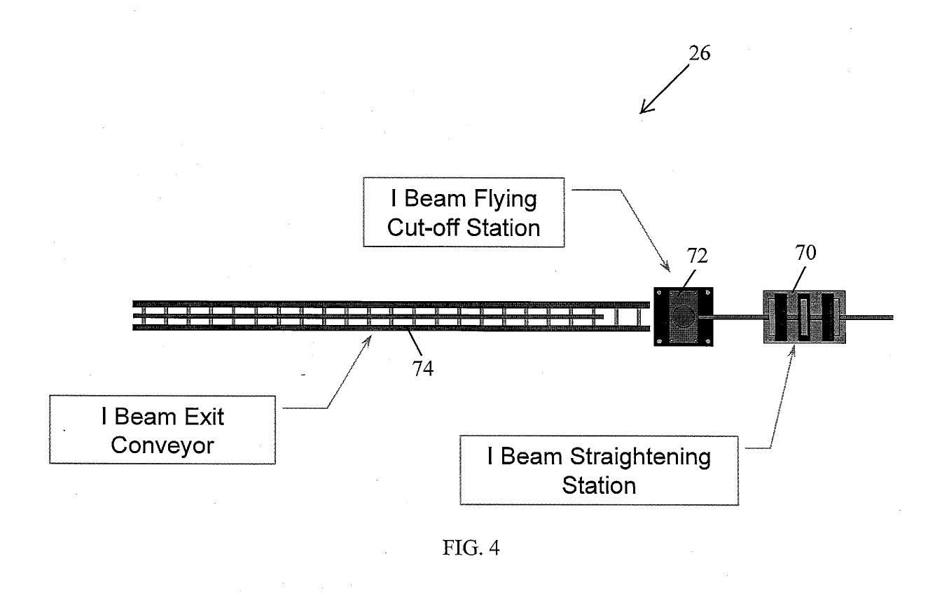

One illustrative arrangement of an exit subsystem 26 is illustrated in greater detail in FIG. 4. Exit subsystem 26, in the illustrated example, includes a beam straightening station 70, a flying cutoff station 72, and an exit conveyor 74. Beam straightening station 70 may be a conventional beam straightening section that is adapted to straighten out any bends, curves, or other non-straight portions of beam 68 that may have developed during the welding of the beam. Flying cutoff station 72 may also be a conventional flying cutoff station that is adapted to cut the beam 68 into linear sections of a desired length. Station 72 may be configurable to cut beam 68 into sections of different length. Regardless of the specific length of the beam cut by station 72, station 72 is adapted to make such cuts while the beam 68 is moving in downstream direction 28. This allows system 20 to operate in a continuous fashion such that beam 68 may be continuously moved on conveyors 60 and 66 without having to stop or slow down for it to be cut into sections. Flying cutoff station 72 delivers the sections of beam 68 to exit conveyor 74, which may then further transport the beam sections to any suitable accumulation, storage, transport, or other area of the plant. From there, the beam sections may be shipped to customers or to other locations.

FIG. 5 illustrates one example of a configuration of laser welders 50-56 that may be used to manufacture metal I-beams in accordance with beam manufacturing system 20. As can be seen in FIG. 5, each laser welder 50-56 emits a laser beam 76 that impinges beam 68. More specifically, the laser beams 76 from laser welders 50 and 52 impinge beam 68 at an upper junction 78 defined by the junction of top flange 36 with a top end of web 40. The laser beams 76 of laser welders 54 and 56 impinge beam 68 at a lower junction 80 defined by the junction of bottom flange 38 with a bottom end of web 40. Laser welders 50 and 56 impinge upper and lower junctions 78 and 80, respectively, along a first side 82 of beam 68. Laser welders 52 and 54 impinge upper and lower junctions 78 and 80, respectively, along a second side 84 of beam 68.

In the example shown in FIG. 5, each laser beam 76 is oriented at an angle theta (Θ) with respect to a plane 86 defined by the extension of either top or bottom flange 36 or 38. In at least one embodiment, theta may be set to an angle of substantially fifteen degrees. Other angles may also be used, including, but not limited to, angles at least as small as ten degrees and angles at least as large as twenty degrees.

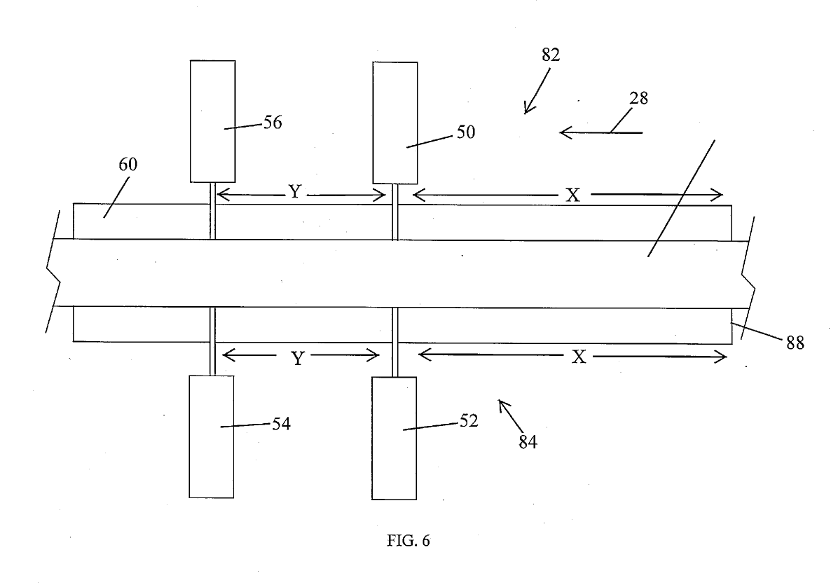

Beam manufacturing system 20 is set up, in at least one embodiment, such that first laser welder 50 and second laser welder 52 are positioned such that their respective welding occurs at substantially the same longitudinal location of beam 68. This may more easily be understood with respect to FIG. 6, which shows a plan view diagram of a beam 68 undergoing welding while traveling on conveyor 60 in downstream direction 28. First laser welder 50 occupies a position that is spaced longitudinally from an upstream end 88 of conveyor 60 by a distance of X. Second laser welder 52 is also spaced from upstream end 88 of conveyor 60 by the same distance X. As a result, first and second welders 50 and 52 will weld at substantially the same longitudinal location along beam 68 as beam 68 is manufactured. This helps ensure that the heat generated within beam 68 by first laser welder 50 on first side 82 of beam 68 is matched by the heat generated within beam 68 by second laser welder 52 on second side 84 of beam 68. That is, both sides 82 and 84 of beam 68 will be heated at substantially the same location and at substantially the same time by the welding carried out by welders 50 and 52. Because the heat of the welding is therefore substantially balanced on both sides of the beam 68, this helps prevent or reduce any undesirable twisting, bending, warping, or other misalignment of top flange 36 out of the desired ninety-degree orientation with respect to web 40.

In the example illustrated in FIG. 6, third and fourth laser welders 54 and 56 are spaced a distance Y downstream of first and second laser welders 50 and 52. Y may be chosen to be equal to any desirable value, including, but not limited to, zero. In order to provide sufficient spacing for laser welders 50-56, it may be desirable in some situations to choose a Y value that is non-zero such that sufficient room is available for positioning all of the laser welders. Regardless of the specific value of Y, it can be seen that third and fourth laser welders 54 and 56 are also positioned at the same longitudinal location along conveyor 60. The longitudinal location is spaced away from upstream end 88 of conveyor 60 by a distance equal to the sum of X and Y. By positioning third and fourth laser welders 54 and 56 at the same location, the same benefits of substantially equal heating and reduced twisting as were discussed above with respect to welders 50 and 52 are reaped.

FIG. 7 illustrates a cross-section of an I-beam 68 manufactured by system 20. More specifically, FIG. 7 depicts examples of the size and shape of weld pools 90 that may be created in beam 68 by the laser welders 50-56. As can be seen therein, each weld pool 90 overlaps, or at least touches, a portion of the adjacent weld pool 90 created on the opposite side of beam 68. Thus, for example, weld pool 90a partially overlaps weld pool 90b. Weld pool 90a may have been formed by first laser welder 50, while weld pool 90b may have been formed by second laser welder 52. By having the weld pools 90a and 90b overlap, or at least touch, no portion of the junction between top flange 36 and web 40 is left un-welded. This helps create a stronger weld between top flange 36 and web 40. The same is true of the overlapping, or touching, weld pools 90 positioned at the junction of web 40 with bottom flange 38.

Beam manufacturing system 20 may be used to create beams that are made entirely of a single type of metal, such as steel, aluminum, or other metals. In other embodiments, system 20 may be used to create composite beams 68—i.e. beams that have components made from different types of metal. For example, system 20 could be used to manufacture beams 68 in which web 40 might be made from a different metal than top and bottom flanges 36 and 38. In still other embodiments, each of the three components of an I-beam (top flange 36, bottom flange 38, and web 40) might be made from a metal that is different from the other two components. In still other embodiments, one of the flanges 36 or 38 could be made from a metal that differs from both the other flange and web 40.

As would be understood by one skilled in the art, each of the laser welders 50-56 may be configured in a manner suitable for creating the desired welds. Such configuration may involve choosing the focal length of the laser welder, the laser spot size, the focus position, the power setting, any offset of the center of the laser beam from the junction of the two components being welded together, and other factors. Such factors may vary depending upon the metal being welded, the speed of conveyor 60, the thickness of the components being welded, the type of laser welder, and other factors. In at least one embodiment, where top and bottom flanges 36 and 38 were both 0.120 inches thick and web 40 was 0.090 inches thick (all from 80 ksi steel), a sufficient weld was created at a line speed of twelve meters per second using a laser welder with a 400 micron laser spot size focused on the surface of the metal and angled at fifteen degrees (theta=15) with an offset of 0.008 inches (above the junction between the web and flange). Other laser spot sizes, offsets, and/or angles may also be used for the same line speed, material, and material thicknesses. Of course, system 20 may also be used with other materials, other material thicknesses, other line speeds, other angles, other offsets, and still other parameters.

System 20 may be modified to punch holes at selected locations, or otherwise remove selected amounts of material at selected locations, along beam 68 after its components have been welded together. Such removal of material may be beneficial in reducing the weight of the final beam sections that are created. The location of the material that is removed may be chosen so as to not decrease the desired structural properties of the beam beyond acceptable standards. Because system 20 utilizes laser welders that focus their welding heat, beams 68 cool off at a faster rate than other types of welding, such as gas metal arc welding. This faster cooling rate allows further processing to be performed while the beam 68 is still moving on the line, if desired. Such processing may include, for example, the removal of material, as noted, or it may involve other procedures. Thus, system 20 may, in one embodiment, remove material from the manufactured beam 68 while the beam is still moving down the line. Alternatively, the material may be removed after beam 68 has been cut into sections by flying cutoff station 72.

Beam manufacturing system 20 may provide a more flexible system for manufacturing metal beams, such as, but not limited to, I-beams. System 20 may be easily adapted to allow the customized creation of I-beams. By changing the laser welder settings appropriately and/or the line speeds, I-beams having flanges and webs of different thicknesses, as well as differing types of materials, may be easily manufactured in an economical manner. Further, control panel 62 may be configured with a controller that stores the various laser welder settings, the line speed, and/or other features of the manufacturing process such that an operator can recall the settings for later use. This allows an operator to create a batch of customized beams for a customer at a first time period and then, if desired, electronically recall those settings from the controller at a later time to create another batch of the same customized beams. The controller may be further configured to automatically implement the saved settings on all of the equipment used in the system 20, thereby enabling customized system 20 to switch to manufacturing a different type of beam with little manual effort.

As would be understood by one skilled in the art, additional changes and modifications in the specifically described embodiments may be carried out with departing from the principles of the present invention, which is intended to be limited only by the scope of appended claims, as interpreted according to the principles of patent law, including the doctrine of equivalents.

1. A system for making metal beams comprising:
a coil feed subsystem adapted to feed a metal flange and a metal web to a welding area;
said metal flange and said metal web being fed from first and second coils, respectively;
a conveyor positioned in said welding area and adapted to continuously move said metal flange and metal web in a downstream direction away from said coil feed subsystem, said metal flange and metal web being in contact with each other along a junction as said flange and web move on said conveyor;
a first laser welder positioned in said welding area, said first laser welder adapted to weld said metal flange to said metal web along a first side of said junction as said metal flange and metal web move; and
a second laser welder positioned in said welding area, said second laser welder adapted to weld said metal flange to said metal web along a second side of said junction as said metal flange and metal web move, said second laser welder further adapted to weld along said second side of said junction at substantially the same longitudinal position as said first laser welder welds along said first side of said junction.

2. The system of claim 1 wherein said coil feed subsystem is further adapted to feed a second metal flange to said welding area such that said second metal flange is in contact with said web along a second junction opposite to said junction between said metal flange and said web.

3. The system of claim 2 further including:
a third laser welder positioned in said welding area, said third laser adapted to weld said second metal flange to said metal web along a first side of said second junction as said second metal flange and metal web move; and
a fourth laser welder positioned in said welding area, said fourth laser welder adapted to weld said second metal flange to said metal web along a second side of said second junction as said second metal flange and said metal web move, said fourth laser further adapted to weld along said second side of said second junction at substantially the same longitudinal position as said third laser welder welds along said first side of said second junction.

4. The system of claim 3 wherein said first and second laser welders weld along said junction at substantially the same longitudinal position as said third and fourth welders weld along said second junction.

5. The system of claim 3 wherein said metal flange and said second metal flange are welded to said web in a configuration that defines an I-beam.

6. The system of claim 5 further including a flying cutoff station positioned downstream of said welding area, said flying cutoff station adapted to cut said welded I-beam into sections as said I-beam moves.

7. The system of claim 1 wherein said first laser welder generates a first weld pool along said first side of said junction, and said second laser welder generates a second weld pool along said second side of said junction, wherein said first and second weld pools intersect each other.

8. The system of claim 7 wherein said first and second weld pools collectively extend across said web from a first side of said web to a second side of said web.

9. The system of claim 1 wherein said conveyor moves said metal flange and said web at a speed at least as great as fourteen meters per minute while said first and second welders weld along said junction.

10. The system of claim 1 wherein said first laser welder emits a laser beam oriented at an angle of approximately fifteen degrees with respect to a plane defined by said metal flange.

11. The system of claim 1 wherein said metal flange and said metal web are made of different types of metals.

12. The system of claim 1 wherein said metal flange and said metal web are both made of steel.

13. The system of claim 12 wherein said metal web has a thickness of at least 0.08 inches, the metal flange has a thickness of at least 0.11 inches, and the first and second laser welders generate a spot size of at least 300 microns.

14. The system of claim 1 wherein filler material is not added to the junction of the metal web and the metal flange as said first and second laser welders weld along said junction.

15. A method of manufacturing a metal I-beam comprising:
feeding a bottom metal flange from a first coil to a welding area;
feeding a top metal flange from a second coil to the welding area;
feeding a metal web from a third coil to the welding area;
laser welding said bottom metal flange to said metal web and said top metal flange to said metal web to thereby create an I-beam, said laser welding occurring as said top and bottom metal flanges and said web move on a conveyor; and
cutting said welded top I-beam into sections downstream of the welding area while said I-beam is in motion.

16. The method of claim 15 further including performing said laser welding using four laser welders.

17. The method of claim 16 further including keeping said four laser welders stationary as said four laser welders perform said laser welding.

18. The method of claim 15 wherein at least one of said bottom metal flange, top metal flange, and metal web are made from a metal different from at least one other of the bottom metal flange, top metal flange, and metal web.

19. The method of claim 15 further including configuring said laser welders such that said first and second laser welders generate overlapping weld pools, and said third and fourth laser welders generate overlapping weld pools.

20. A system for making metal I-beams comprising:
a coil feed subsystem adapted to feed a top metal flange, a bottom metal flange, and a metal web to a welding area; said top metal flange, said bottom metal flange, and said metal web being fed from first, second, and third coils, respectively;
a conveyor positioned in said welding area and adapted to continuously move said top metal flange, said bottom metal flange, and said metal web in a downstream direction away from said coil feed subsystem, said top metal flange and metal web being in contact with each other along a first junction as said top flange and web move on said conveyor, and said bottom metal flange and said metal web being in contact with each other along a second junction as said bottom flange and web move on said conveyor;
a first laser welder positioned in said welding area, said first laser welder adapted to weld said top metal flange to said metal web along a first side of said first junction as said top metal flange and metal web move;
a second laser welder positioned in said welding area, said second laser welder adapted to weld said top metal flange to said metal web along a second side of said first junction as said top metal flange and metal web move,
a third laser welder positioned in said welding area, said third laser welder adapted to weld said bottom metal flange to said metal web along a first side of said second junction as said bottom metal flange and metal web move; and
a fourth laser welder positioned in said welding area, said fourth laser welder adapted to weld said bottom metal flange to said metal web along a second side of said second junction as said bottom metal flange and metal web move.

21. The system of claim 20 wherein said first and second laser welder are positioned at a longitudinal location along said conveyor such that a first laser beam emitted from said first laser welder and a second laser beam emitted from said second laser welder simultaneously impact said first junction at a common longitudinal location along said first junction.
